(19) United States
(12) Patent Application Publication
(10) Pub. No.: US 2011/0282509 A1
(43) Pub. Date: Nov. 17, 2011

(54) OCCUPANCY BASED SWITCHING WITH ADVANCE NOTIFICATION

(75) Inventors: Sural Yegin, Chula Vista, CA (US); Kenneth J. Brown, Chula Vista, CA (US); Carlos Ramirez, Tijuana (MX)

(73) Assignee: LEVITON MANUFACTURING CO., INC., Melville, NY (US)

(21) Appl. No.: 12/778,014

(22) Filed: May 11, 2010

(51) Int. Cl. G06F 1/26

(52) U.S. Cl. 700/295

(57) ABSTRACT

A system may include an occupancy sensor and an interface to couple the occupancy sensor to equipment that may perform a power reduction operation in response to the occupancy sensor. Another system may include an occupancy sensor and a switch to control power to equipment in response to the occupancy sensor, where an advance notification is sent to the equipment before the switch interrupts power to the equipment. In one embodiment, the switch may interrupt the power after a time delay from when the advance notification is sent. In another embodiment, the switch may not interrupt the power until a response to the advance notification is confirmed.

### BACKGROUND

Occupancy sensing technologies are used to monitor the presence of occupants in indoor and outdoor spaces. Occupancy sensing systems conserve energy by automatically turning off lighting and other electrical loads when the space is unoccupied or vacant. They may also perform a convenience function by automatically turning on lighting and other loads when an occupant enters a space. An occupancy sensor typically includes a count-down timer that is reset to a predetermined time, e.g., 10, 20 or 30 minutes, each time the sensor detects an occupant. If the timer counts all the way down to zero (times out) before an occupant is detected, the occupancy sensor turns off the load. In some configurations, an occupancy sensor may require a user to manually turn the load back on after it times out. In other configurations, after timing out, the occupancy sensor may turn the load back on as soon as it detects an occupant again.

Other existing energy conservation measures for homes, offices, and other locations involve the use of shut-down, sleep, suspend, hibernate, and other low power modes with computers and other electronic devices. These measures utilize conventional inputs to a computer or other device to determine that the device is no longer being used and reduce the power consumption accordingly. For example, a computer may be configured to turn off a display screen after 20 minutes of non-use as defined by the absence of any actuations of the computer keyboard. The computer may further be configured to turn off a hard disk drive after 40 minutes of non-use, and completely shut down the computer or enter a sleep or hibernate mode after 60 minutes of non-use. These measures only provide a rough guess as to whether the computer and its various components should actually be turned off. A user's attention may be temporarily diverted to paper documents long enough to cause the computer to begin a turn-off sequence just as the user was about to begin actively using the computer again. Conversely, a user may walk away from a computer workstation, but the computer will wait an entire 60 minutes before powering down.

### BRIEF DESCRIPTION OF THE DRAWINGS

FIG. 1 illustrates an embodiment of an occupancy sensing system according to some inventive principles of this patent disclosure.

FIGS. 2-4 illustrate example embodiments of techniques for implementing the system of FIG. 1 according to some inventive principles of this patent disclosure.

FIG. 5 illustrates another embodiment of an occupancy sensing system according to some inventive principles of this patent disclosure.

FIGS. 6-11 illustrate example embodiments of techniques for implementing the system of FIG. 5 according to some inventive principles of this patent disclosure.

FIG. 12 illustrates an embodiment of a power strip having occupancy sensing functionality according to some inventive principles of this patent disclosure.

FIG. 13 is a perspective view of an example embodiment of a power strip having some of the features disclosed in the system of FIG. 12 according to some inventive principles of this patent disclosure.

FIG. 14 illustrates another embodiment of a power strip having occupancy sensing functionality according to some inventive principles of this patent disclosure.

FIG. 15 illustrates another embodiment of an occupancy sensing system according to some inventive principles of this patent disclosure.

FIG. 16 illustrates another example embodiment of an occupancy sensing system according to some inventive principles of this patent disclosure.

### DETAILED DESCRIPTION

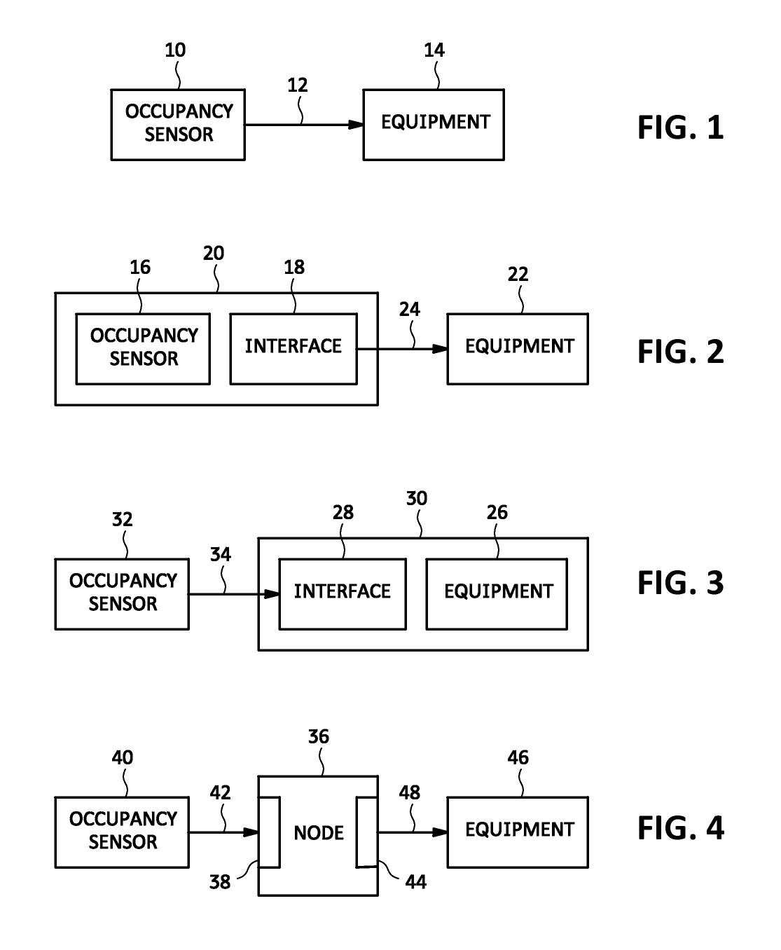

FIG. 1 illustrates an embodiment of an occupancy sensing system according to some inventive principles of this patent disclosure. The system of FIG. 1 includes an occupancy sensor 10 that may communicate through a link 12 with equipment 14 which has power-down or other type of built-in power reduction capabilities. The equipment 14 in the embodiment of FIG. 1, and in other embodiments disclosed in this patent disclosure, may include, for example, a computer, a printer, audio visual (A/V) equipment, a photocopier, etc., that has a turn-off, hibernate, sleep, suspend, or other type of reduced power mode that can be invoked.

The occupancy sensor 10 in the embodiment of FIG. 1, and in other embodiments disclosed in this patent disclosure, may employ any suitable occupancy sensing technology such as infrared (IR), ultrasound (U/S), video imaging, etc., or any combination of technologies. The occupancy sensor may be implemented in any form that is separate from, or integral with, the equipment. Examples include wall-mount, ceiling-mount, or table-top units, cord-attached pendants, etc. The communication link 12 may be hard-wired, wireless, optical, etc., and use any suitable communication protocol and/or hardware.

The equipment 14 in the embodiment of FIG. 1, and in other embodiments disclosed in this patent disclosure, may enter a reduced power mode in response to a determination by the occupancy sensor that a space including or associated with the equipment has become unoccupied. The reduced power mode may be entered immediately upon a determination of unoccupied status, or after a fixed or variable time delay. A process for entering a reduced power mode may also involve supervisory control, verification or authorization by another system or person or by the equipment itself, and/or it may involve time-of-day, day-of-week, calendar, ambient light and other factors in determining whether to enter a reduced power mode.

FIG. 2 illustrates another embodiment of an occupancy sensing system according to some inventive principles of this patent disclosure. The system of FIG. 2 may be used, for example, to implement the system of FIG. 1. The occupancy sensor 16 is included in an assembly 20 with an interface 18 to enable to the occupancy sensor 16 to communicate through a link 24 with equipment 22 which has power-down or other type of built-in power reduction capabilities. Some examples of suitable interfaces include Universal Serial Bus (USB) or IEEE-1394 (FireWire) interfaces that enable the assembly to communicate with a computer, printer, monitor, camera or other USB or FireWire compatible electronic device to enable the device to perform a power reduction operation in response to the occupancy sensor. Some other examples of suitable interfaces include infrared interfaces such as Infrared Data Association (IrDA) compliant interfaces; radio frequency (RF) interfaces including interfaces based on standards such as Zig-Bee, Z-Wave, EnOcean Alliance, Bluetooth, and wireless Ethernet such as Wi-Fi; and interfaces based on other wired and wireless protocols such as RS-232 serial communications, wired Ethernet, Control Area Network (CAN), LonWorks, etc.

FIG. 3 illustrates another embodiment of an occupancy sensing system according to some inventive principles of this patent disclosure. The system of FIG. 3 illustrates another example technique for implementing the system of FIG. 1. In the embodiment of FIG. 3, the equipment 26 is included in an assembly 30 with an interface 28 to enable the equipment to communicate with the occupancy sensor 32 through a communication link 34. Examples of suitable interfaces and/or links include a standard hardwired 24 VDC occupancy sensor interfaces; wireless occupancy sensor interfaces such as those based on standards by EnOcean Alliance, Zig-Bee, Z-Wave and others; and interfaces based on power-line communications such as the X10 standard for home automation, etc.

FIG. 4 illustrates another embodiment of an occupancy sensing system according to some inventive principles of this patent disclosure. The system of FIG. 4 illustrates yet another technique for implementing the system of FIG. 1. The embodiment of FIG. 4 includes a node 36 having a first interface 38 to communicate with occupancy sensor 40 through a first link 42, and a second interface 44 to communicate with equipment 46 through a second link 48. The node 36 may be implemented separately from, or integral with, the occupancy sensor 40 and/or equipment 46 and may operate as an adapter or translator. For example, the first interface 38 may implement a standard 24 VDC wired occupancy sensor interface, or a wireless occupancy sensor interface based on a standard by EnOcean Alliance, Zig-Bee, Z-Wave or others. The second interface 44, may implement a standardized computer communication interface such as RS-232 serial communications, USB, FireWire, etc. Thus, depending on the implementation, a node 36 may enable the realization of an occupancy based power-reduction system that largely utilizes existing occupancy sensors and equipment.

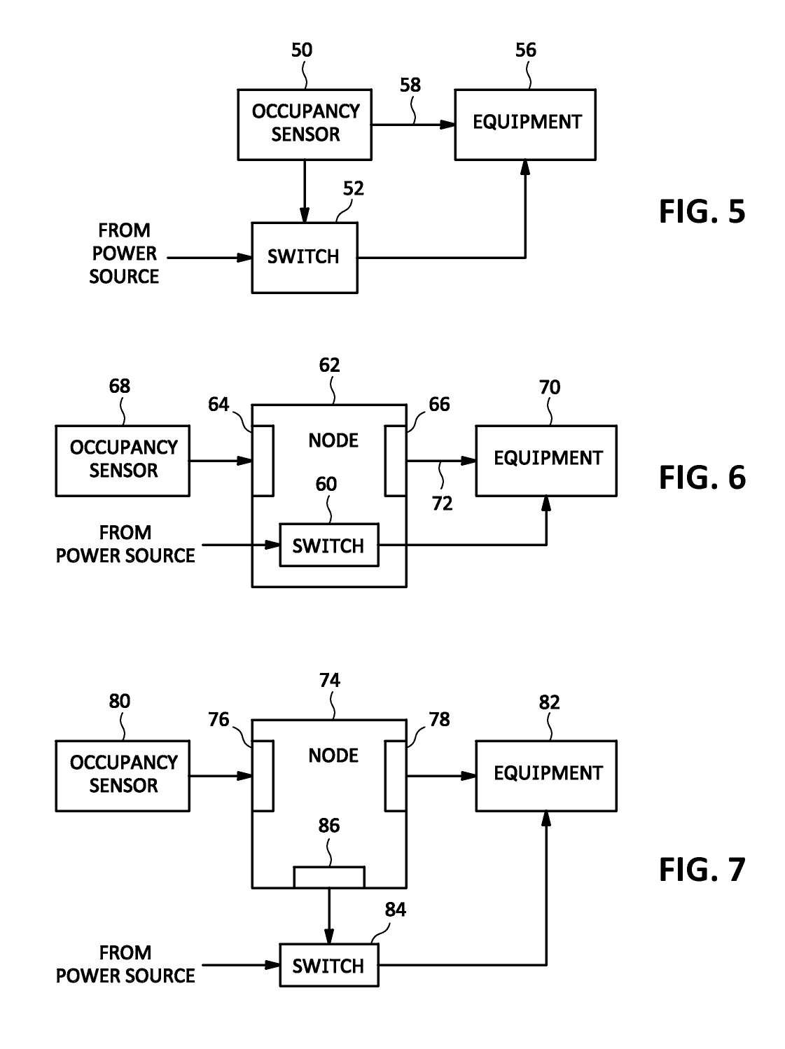

FIG. 5 illustrates another embodiment of an occupancy sensing system according to some inventive principles of this patent disclosure. The embodiment of FIG. 5 includes an occupancy sensor 50 and a switch 52 to control the flow of power from a power source to equipment 56 in response to the occupancy sensor. The equipment 56 may require, or benefit from, advance notification when the switch will interrupt or disturb the flow of power to the equipment. Therefore, an advance notification 58 is provided to the equipment 56 to enable the equipment to begin an orderly power-down sequence or take other action in anticipation of an interruption or disturbance of the source of power by the switch 52.

The equipment may or may not include power-down or other type of built-in power reduction functionality. For example, some computers have a power switch that can only be operated manually. If the power switch is turned off during normal operation, data may be lost or the computer maybe damaged. Therefore, the computer typically has a shut-down sequence that can be invoked by the user to save any data and/or configuration information prior to turning off the power switch. The operating system typically performs the shut-down sequence, then provides a message to the user indicating that it is safe to turn off the computer. As another example, some other types of equipment such as a television may not have time to store the current channel and/or volume levels in nonvolatile memory if power is interrupted abruptly during normal operation rather than after an orderly shut-down sequence. As yet another example, if the supply of power to a printer or copy machine is suddenly interrupted during a printing cycle, the machine may jam, or the image on a sheet of paper may be only partially fused or processed in a manner that cannot be resumed when power is restored.

By providing an advance notification, the embodiment of FIG. 5 may enable the equipment to perform a power reduction operation, save data or configuration information, complete an operating cycle, or take any other action in anticipation of an interruption or disturbance of the source of power.

The advance notification may be provided to the equipment 56 directly by the occupancy sensor 50, through the switch 52, e.g., through power line communications, or through any other intermediary apparatus. The communication links shown in the embodiment of FIG. 5 may be implemented with any wired or wireless links such as those described above with respect to the embodiments above.

The advance notification may be in any suitable form including a binary on-off signal, an analog signal, a multi-bit digital signal, a sequence of one or more control characters, a transfer of executable code to the equipment, etc.

The advance notification may be provided to all or only a portion of the equipment. For example, the equipment 56 may include a first portion, such as a computer that has built-in shut-down functionality, and a second portion such as a computer peripheral or task light that would not benefit from an advance notification.

The system of FIG. 5 may include timing functionality to control the relative timing of the advance notification 58 and the operation of the switch 52. The timing functionality may be included with the occupancy sensor 50, the switch 52, the equipment 58, a separate unit, or in any other suitable configuration.

The power source 54 may include any suitable source of power for the equipment including conventional AC power from a power grid or generator, DC power from a battery, AC/DC converter, battery pack, etc.

The switch 52 may provide on-off and/or continuous power control and may include electromechanical or solid state relays, thyristors such as Triacs or silicon controlled rectifiers (SCRs) to provide on-off or phase control of power, transistors, or any other suitable switching devices.

The switch 52 may be arranged to control power to all or only a portion of the equipment.

For example, the equipment 56 may include a first portion, such as a computer, that is always energized (even after receiving an advance notification and executing a shut-down sequence), and a second portion, such as a computer peripheral or task light that is turned off by the switch in response to the occupancy sensor 50.

The components illustrated in FIG. 5 may all be separate, or may be integrated in any suitable combination or combinations of physical configurations, some examples of which are described below.

FIG. 6 illustrates another embodiment of an occupancy sensing system according to some inventive principles of this patent disclosure. The embodiment of FIG. 6 may be used, for example, to implement the system of FIG. 5. In the embodiment of FIG. 6, the switch 60 is included in a node 62 that includes interfaces 64 and 66 for communicating with the occupancy sensor 68 and equipment 70, respectively. Some examples of physical forms suitable for the node 62 include power strips, power packs, receptacles, in-line modules in cords, wall switches, surge protectors, surge panels, relay cabinets, etc. The interfaces 64 and 66 may be implemented in any suitable manner including those described above with respect to FIG. 4, and timing functionality may be included anywhere in the system to control the relative timing of an advance notification signal 72, which is provided in response to the occupancy sensor 68, and the operation of the switch 60.

FIG. 7 illustrates another embodiment of an occupancy sensing system according to some inventive principles of this patent disclosure. As with the embodiment of FIG. 6, the embodiment of FIG. 7 includes a node 74 having interfaces 76 and 78 for communicating with the occupancy sensor 80 and equipment 82, respectively. However, in the embodiment of FIG. 7, the switch 84 is separate from the node 74, which includes a third interface 86 for controlling the switch 84. Some examples of physical forms suitable for the node 74 include network adapters, table-top boxes, hand-held devices, add-in cards for computers, USB adapters, etc. Any suitable type of interface may be used to couple the switch to the node including any of the wired or wireless interfaces described throughout this patent disclosure.

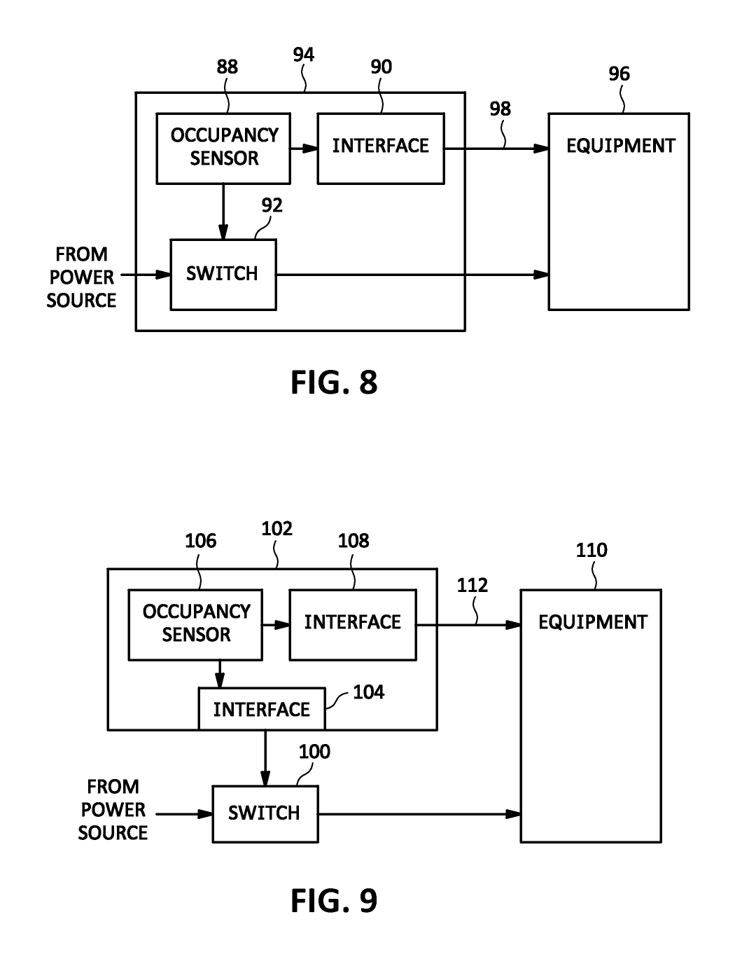

FIG. 8 illustrates another embodiment of an occupancy sensing system according to some inventive principles of this patent disclosure. The embodiment of FIG. 8 provides another example of a technique for implementing the system of FIG. 5. In the embodiment of FIG. 8, the occupancy sensor 88, interface 90 and switch 92 are arranged in a common assembly 94. Some examples of physical forms suitable for the assembly 94 include power strips, receptacles, in-line modules in cords, wall switches, surge protectors, ceiling-mount units, wall-mount units, table-top units, and any other apparatus that may be positioned in a location that enables the occupancy sensor to monitor a space and provide switching and an advance notification signal 98 for the equipment 96.

The interface 90 may be implemented in any suitable manner including those described above with respect to FIG. 4, and timing functionality may be included anywhere in the system to control the relative timing of the advance notification signal 98, which is provided in response to the occupancy sensor 88, and the operation of the switch 92.

FIG. 9 illustrates another embodiment of an occupancy sensing system according to some inventive principles of this patent disclosure. The embodiment of FIG. 9 is similar to that of FIG. 8, but the switch 100 is separate from the assembly 102 that includes the occupancy sensor 106 and interface 108. A second interface 104 couples the switch 100 to the occupancy sensor 106 and/or any timing logic. Some examples of physical forms suitable for the assembly 102 include wall-mount occupancy sensors, ceiling-mount occupancy sensors, and table-top units with wired and/or wireless connections to the switch 100 and equipment 110. In this configuration, the system may be able to utilize existing apparatus for the switch and equipment. Alternatively, the two interfaces 104 and 108 may be implemented as a single interface.

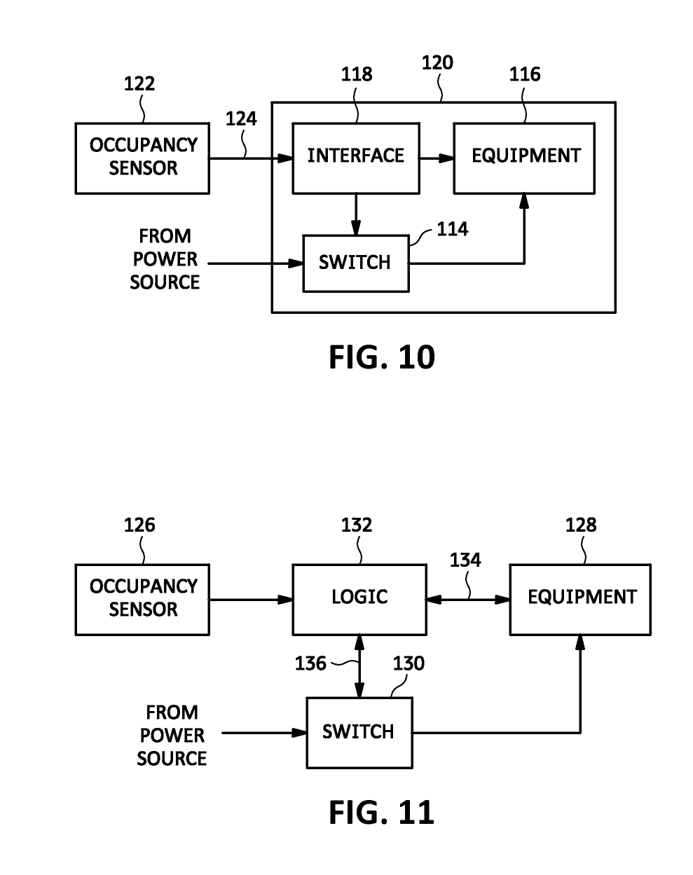

FIG. 10 illustrates another embodiment of an occupancy sensing system according to some inventive principles of this patent disclosure. In the embodiment of FIG. 10, the switch 114, equipment 116 and interface 118 are arranged in an assembly 120 that receives an occupancy signal 124 from an occupancy sensor 122. Some examples of physical forms suitable for the assembly 120 include computers, printers, monitors, other computer peripherals, A/V equipment, etc., that may be provided or retrofitted with an interface 118 to accept a wired or wireless occupancy signal 124 from occupancy sensor 122. For example, the interface 118 may be realized as an add-on card to accept a wired 24 VDC input or a wireless input from an occupancy sensor 122.

FIG. 11 illustrates another embodiment of an occupancy sensing system according to some inventive principles of this patent disclosure. As with the embodiment of FIG. 5, the embodiment of FIG. 11 includes an occupancy sensor 126, equipment 128 and a switch 130 to control the flow of power from a power source to equipment 128 in response to the occupancy sensor 126. In the embodiment of FIG. 11, however, logic 132 is included to accommodate bi-directional communication on links 134 and 136 to and from the equipment 128 and/or switch 130. The bi-directional communication may enable the system to adapt or change its operation based on factors such as receiving confirmation or acknowledgement from the equipment 128 that the equipment has successfully completed an operation to shut-down, save data, or save configuration information in response to an advance notification. The bi-directional communication may enable the system to adapt or change its operation based on feedback from the switch 130. The switch may provide feedback, for example, by monitoring current through the switch to confirm that the equipment has completed a power-down operation before causing the switch 130 to interrupt power to the equipment. Alternatively, the switch may be used as a port for power-line communications with the equipment 128, thereby eliminating or reducing the need for link 134.

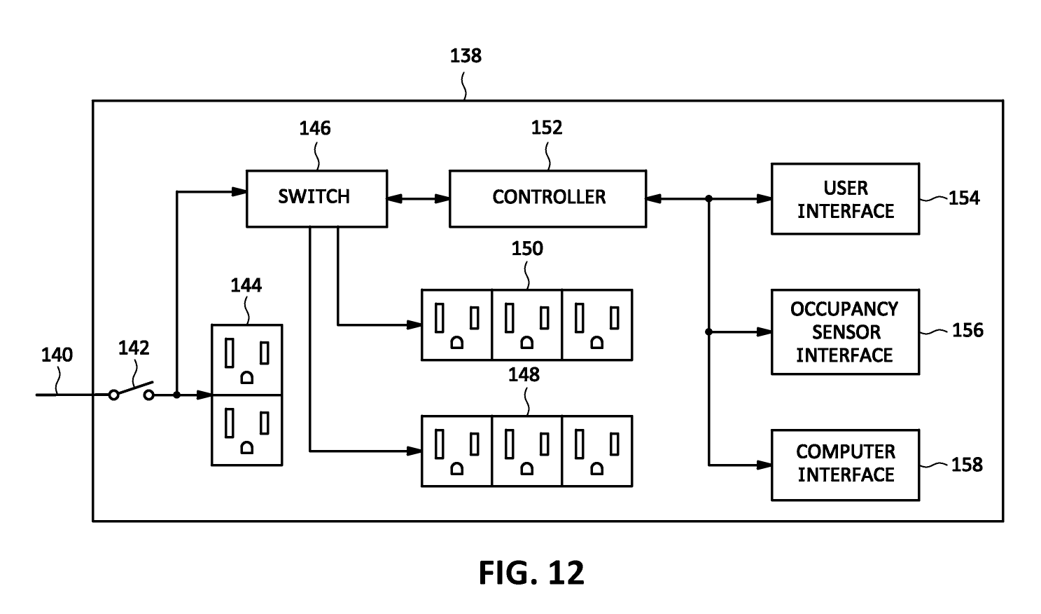

FIG. 12 illustrates an embodiment of a power strip having occupancy sensing functionality according to some inventive principles of this patent disclosure. For purposes of illustration, the system of FIG. 12 includes some specific implementation details, but the inventive principles are not limited to these details.

The power strip of FIG. 12 includes a housing 138 that receives input power from a connection 140 which may include a plug-and-cord assembly, connector prongs to plug directly into a receptacle, etc. A main switch and/or circuit breaker and/or surge arrestor 142 receives the input power which is distributed directly to a first set of receptacles 144 that are always energized when the power switch 142 is closed. The power is also applied to a switch circuit 146 that controls the flow of power to a second set of receptacles 148 and a third set of receptacles 150. A controller 152 controls the switch circuit 146 and communicates with a user interface 154, an occupancy sensor interface 156 and a computer interface 158.

The occupancy sensor interface 156 enables the power strip to communicate with an occupancy sensor through a wired or wireless connection using any suitable interfacing arrangement. Some suitable examples include a standard 24 VDC occupancy sensor interface, a wired digital interface based on a CAN network, a wireless occupancy sensor interface such as an interface compatible with standards from EnOcean, Zig-Bee, Z-Wave, etc.

The computer interface 158 enables the power strip to communicate with a computer, printer, monitor, other computer peripheral, or other electronic device through any suitable interface. Some examples include a USB interface, RS232 serial interface, Wi-Fi, Ethernet, Bluetooth, Wi-Max, etc. The communications may be for any purpose related to the operation of the power strip such as to request that the computer or other equipment perform a power reduction operation, save data or configuration information, initiate an orderly shut-down sequence, etc. Communication with the power strip may be for purposes of sending an advance notification to the computer that the power strip will be interrupting power to the computer and/or to send a confirmation to the power strip that the computer failed or succeeded in performing a requested operation. The communication may also enable a user to configure and/or control the power strip, enter parameters, check the status or performance history of the power strip, etc.

The user interface 154 may include any type of inputs and/or outputs to enable a user to configure and/or control the power strip, enter parameters, check the status or performance history of the power strip, etc., from the power strip itself. The user interface may include one or more input devices such as a potentiometer or other analog input, digital switches of any type including DIP switches, toggle switches, rotary switches, etc. The user interface may include one or more output devices such as lights, LEDs, numeric displays, alphanumeric displays, dot-matrix displays, etc. The user interface may be configured to enable a user to set one or more time delays that control the operation of the switching circuit as described below, as well as communication protocols, occupancy sensitivity and/or time delay, and/or any other parameters.

The controller 152 may be implemented with analog and/or digital hardware, software, firmware, or any suitable combination.

In some embodiments, the controller 152 in the power strip of FIG. 12 may be configured to turn off one set of switched receptacles 150 as soon it receives a signal from an occupancy sensor indicating that an unoccupied state has been determined. At or about the same time, the controller may send an advance notification to the computer or other device through the computer interface warning that the other set of switched receptacles 148 will be de-energized after a fixed time delay. The controller may then de-energize the second set of switched receptacles 148 at the end of the time delay without regard to any confirmation or communication from other equipment, unless the occupancy sensor detects an occupied condition before the end of the time delay.

Alternatively, in some other embodiments, the controller may configured so that, after an unoccupied condition is detected, the controller sends a request to the computer or other device to perform an anticipatory operation such as an orderly shut-down sequence, saving data or configuration information, etc. If the controller receives a confirmation that the anticipatory operation has been completed successfully, it causes the switching circuit to de-energize the second set of switched receptacles 148. If a confirmation is not received the controller may leave the second set of switched receptacles energized.

In yet other embodiments, the controller may leave the second set of switched receptacles energized regardless of whether it receives a confirmation, since it may not achieve any additional power savings to de-energize the second set of switched receptacles 148 if the equipment powered by that set of receptacles has shut itself down. In still other embodiments, the second set of switched receptacles 148 may be omitted because the equipment with built-in power reduction capability may be plugged into the first set of receptacles 144 that are always energized. In such an embodiment, the equipment with built-in power reduction capability may be configured to receive an advance notification through computer interface 158, even though the power to the first set of receptacles 144 is not interrupted in response to an occupancy sensor.

In some embodiments, multiple occupancy sensors and/or computers or other equipment may be interfaced to the power strip. Individual receptacles may be controlled in a zoned or paired configuration of occupancy sensors, or all of the receptacles may be de-energized (with or without a delay) only if all occupancy sensors detect an unoccupied condition. Likewise, individual receptacles may be controlled in response to receiving individual confirmations from individual computers or other equipment, or the controller may cause all of the receptacles to remain energized if any one piece of equipment fails to return a confirmation.

The advance notification or other request to one or more computers or other equipment may take any suitable form. For example, in systems utilizing RS232 serial communications, dedicated software may be installed on the computer or other equipment to check for, or interpret, a signal from the power strip and then initiate a shut-down or other anticipatory operation. In some embodiments, especially with computers or other equipment having more advanced operating systems and/or USB interfaces, shut-down or other responsive functionality may already exist in the operating system. In such a case, the power strip may only need to send a short message or sequence of control characters to the computer. For example, in Windows XP and later Windows operating systems, a shutdown sequence may be initiated by sending the following command which may be executed by the computer for execution in a window with a command prompt line:
shutdown-s-f-t 120 “message here”
   where the parameter 120 specifies that the system will shut down after 120 seconds, and the text string “message here” is a message that can be displayed advising the user of the impending shut down.

In other embodiments, computer-specific shutdown code may be stored in the power strip itself and uploaded to the computer for execution when an unoccupied condition is detected. Other examples of shutdown code are available from the APC UPS Daemon project at http://www.apcupsd.com.

The system of FIG. 12 may be modified in countless ways in accordance with the inventive principles. For example, any of the receptacles may be omitted, as may the user interface 154, the main power switch 142, etc. An occupancy sensor may be integrated directly into the power strip, or apparatus having the functionality of the power strip may be integrated directly into the computer or other equipment. Any of the functionality may be deleted, expanded or multiplied to provide numerous additional configurations. Other types of interfaces other than USB and/or wireless occupancy sensor interfaces may be used.

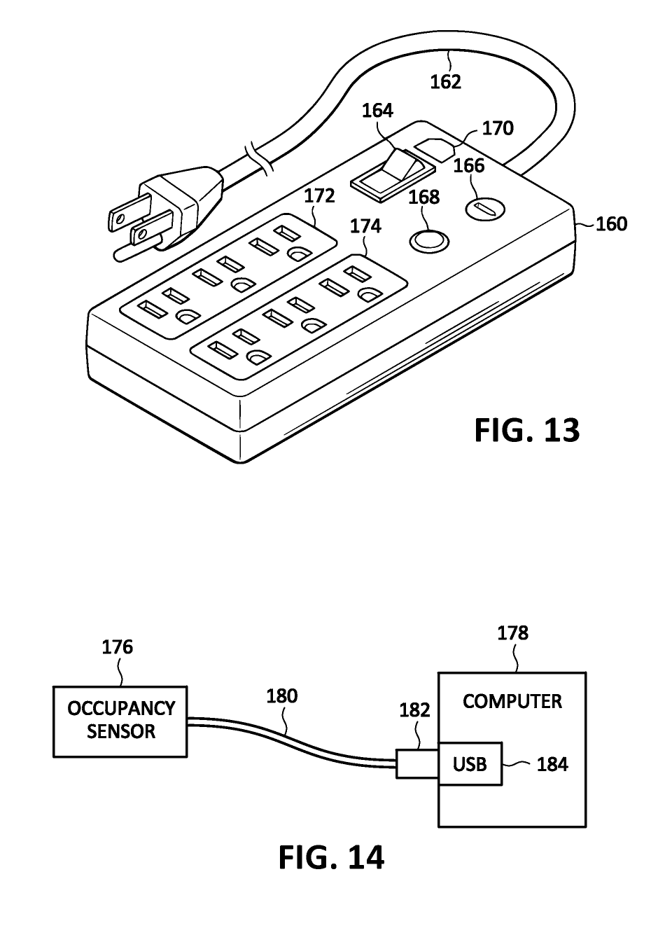

FIG. 13 is a perspective view of an example embodiment of a power strip having some of the features disclosed in the system of FIG. 12. The embodiment of FIG. 13 includes a housing 160, a plug-and-cord assembly 162, a main power switch 164, a trim pot with a dial 166 to enable a user to set a delay time, a wireless receiver 168 for an occupancy sensor, and a type-B USB port 170 for connecting the power strip to a computer or other equipment. When the occupancy sensor indicates an unoccupied condition, a first set of receptacles 172 is de-energized immediately, and an advance notification is sent to the computer or other equipment through the USB port 170. A second set of receptacles 174 are de-energized after a time delay set by the dial 166. Alternatively, the power strip may be configured to only de-energize the second set of receptacles after the computer or other equipment sends a confirmation message.

As another alternative, a receptacle on the power strip may be designated as a control receptacle into which a computer is plugged. Rather than waiting for a confirmation from the computer, the current draw of the control receptacle may be monitored for reduction in current which may indicate that the computer successfully completed a shut-down sequence. The control receptacle and or other receptacles for computer peripherals and other equipment may then be de-energized.

FIG. 14 illustrates another embodiment of a power strip having occupancy sensing functionality according to some inventive principles of this patent disclosure. For purposes of illustration, the system of FIG. 14 includes some specific implementation details, but the inventive principles are not limited to these details. In the embodiment of FIG. 14, an occupancy sensor 176 is connected to a computer 178 through a USB cable 180 having a USB plug or adapter 182. The occupancy sensor may be powered by the peripheral power available through the USB port 184 on the computer. The occupancy sensor may be place in any suitable position to monitor the space related to the computer. Upon sensing an unoccupied condition, the occupancy sensor may send a request to the computer, which, in response, may initiate a built-in shut-down or power reduction operation. Upon detecting an occupied condition, the occupancy sensor may send another request to the computer to initiate a power-up, wake-up, or other suitable operation.

As with any of the embodiments described in this patent disclosure, the embodiment of FIG. 14 may be modified in countless ways in accordance with the inventive principles. For example, the computer may be replaced by a printer, copier or any other equipment having built-in shut-down or power reduction capability. The USB cable may be replaced with FireWire or any other wired or wireless interface. The occupancy sensor may be operated from a separate source of power such as AC power, batteries, photovoltaic cells, or any combination of sources.

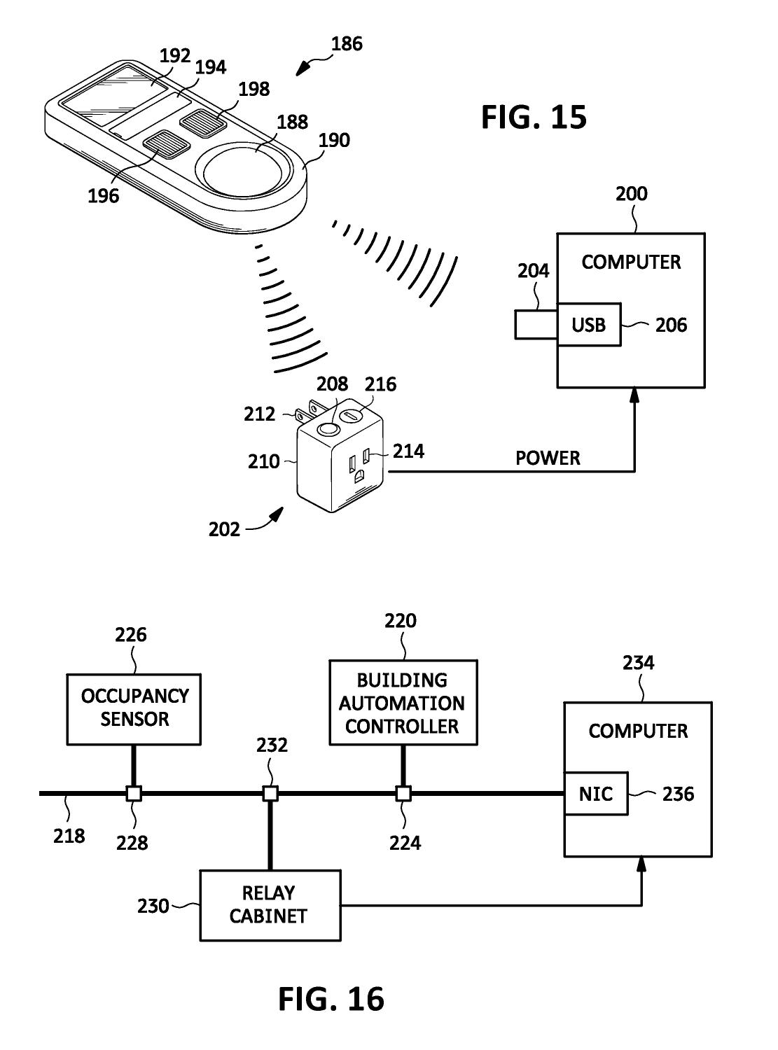

FIG. 15 illustrates another embodiment of an occupancy sensing system according to some inventive principles of this patent disclosure. Again, for purposes of illustration, the system of FIG. 15 includes some specific implementation details, but the inventive principles are not limited to these details.

The embodiment of FIG. 15 includes a wireless occupancy sensor 186 that includes a passive infrared (PIR) detector 188 in a housing 190 that may be mounted permanently to a building with screws, clips, glue, etc., mounted temporarily to a building, for example, with removable or repositionable two-sided tape, hook-and-loop fasteners, etc., or left unattached on a shelf, desk, cabinet, etc., in a location that provides the PIR sensor with an adequate field of view of the monitored space.

In this example, the occupancy sensor also includes a photovoltaic (PV) cell 192 to provide the primary source of power for the sensor and recharge one or more batteries on which the occupancy sensor runs when inadequate ambient light is available. An access cover 194 may provide access to controls for the PIR sensing operation such as range, sensitivity, field of interest, learn mode, etc. In some embodiments, the occupancy sensor may include one or more additional detectors 196 and 198 which may include, for example, ultrasonic transducers, audio transducers, etc., or any combination thereof.

In this embodiment, the occupancy sensor may communicate with a computer 200 and a plug-in switching device 202 through one or more RF transmitters which may be enclosed within the housing if it is fabricated from plastic or other material that does not block RF signals. The RF transmitters may be configured to flood the entire monitored space with RF signals to enable any devices in the space to respond to the occupancy sensor.

In this embodiment, the occupancy sensor may communicate with the computer through a wireless receiver or transceiver built into a USB dongle 204 that can be plugged into a USB port 206 on the computer. The occupancy sensor may also communicate with the plug-in switching module 202 through a receiver or transceiver 208. The plug-in switching module may be configured as a portable in-line power switch having a body 210 with blades to form a power plug 212 extending from the back of the body to connect the device to a standard wall receptacle. A switched receptacle 214 is formed in the front of the body. A power switch inside the body controls the flow of power from the plug 212 to the receptacle 214 in response to a wireless signal from the occupancy sensor received by the wireless receiver or transceiver 208. A dial 216 enables a user to manually set a delay time.

In some embodiments, the occupancy sensor may use a single transmitter to send the same signal to both the switching device 202 and the USB dongle 204 plugged into the USB port 206 on the computer. The dongle may interpret the wireless signal from the occupancy sensor as a request for shut-down or other anticipatory action and cause the computer to take the requested action. The switching module 202, however, may delay for a predetermined delay time determined by the dial 216 before switching off power to the computer. Alternatively, the switching module 202 may wait to receive a confirmation from the USB dongle before interrupting the power. With either of these alternatives, the occupancy sensor essentially runs open loop and takes a single action in response to detecting an unoccupied condition. In other embodiments, the occupancy sensor 186 may include additional functionality.

For example, the occupancy sensor may communicate with the switching device 202 and computer 200 separately on different frequencies, using different transmitters, or using different codes. Upon detecting an unoccupied state, the occupancy sensor may send a request for shut-down or other anticipatory action to the computer. The occupancy sensor may then delay for a specific time period or wait for a confirmation from the computer before sending a different signal instructing the switching device to switch off power to the computer.

Depending on the implementation details, the system of FIG. 15 may enable the use of existing off-the-shelf components. For example, in some embodiments, an existing wireless occupancy sensor 186 may be used without modification. Also, in some embodiments, an existing plug-in switching module based on Z-Wave or other wireless protocol may be used without modification. In other embodiments, only minor modifications may be needed.

Some additional possible modifications to the system of FIG. 15 according to some inventive principles of this patent disclosure include replacing the wireless connection between the occupancy sensor 186 and computer 200 with power line communication between the switching device 202 and the computer. That is, the switching device may be configured as a bridge or translator between the occupancy sensor and computer. Moreover, any of the wireless connections illustrated in FIG. 15 may be replaced with wired connections.

FIG. 16 illustrates another example embodiment of an occupancy sensing system according to some inventive principles of this patent disclosure. The embodiment of FIG. 16 includes a building network 218 such as an Ethernet, CAN or other type of network suitable for building automation, energy management, etc. A building automation server, workstation, or other controller 220 is connected to the network through network adapter 224. An occupancy sensor 226 is connected to the network through network adapter 228 and provides an indication of the occupied state of the space it is configured to monitor. A switching device 230, which in this example is implemented with a relay in a networked relay cabinet 230 is interfaced to the network through a network adapter 232 and controls the flow of power to a computer 234. The computer 234 or other equipment is interfaced to the network through a network interface card (NIC) 236.

The controller 220 provides all of the operational logic for the system. When the controller receives a message from the occupancy sensor indicating an unoccupied condition, it issues a message to the computer 234 requesting an orderly shut-down or other anticipatory action. After a fixed time delay, or after receiving a confirmation from the computer, the controller commands the relay cabinet to switch off power to the computer. Upon receiving an indication that the monitored space is once again occupied, the controller signals the relay cabinet to restore power to the computer.

Although the inventive principles are not limited to any specific applications, they may be especially effective in schools, libraries, call centers, etc. where large numbers of computers, peripherals and other equipment may be used by ever changing and unpredictable numbers of users, some of whom have little or no incentive, access, or authorization to shut down or reduce the power consumption of the equipment when leaving the vicinity of the equipment.

Any of the logic, functionality, features, circuitry, etc., described above may be implemented with any suitable hardware, software, firmware or any combination thereof.

The inventive principles of this patent disclosure have been described above with reference to some specific example embodiments, but these embodiments can be modified in arrangement and detail without departing from the inventive concepts. Such changes and modifications are considered to fall within the scope of the following claims.

1. A system comprising:
an occupancy sensor adapted to control a switch; and
an interface to couple the occupancy sensor to equipment having built-in power reduction capability;
where the interface is adapted to provide an advance notification to the equipment to enable the equipment to perform a built-in power reduction operation before the switch interrupts power to the equipment.

2. The system of claim 1 where the interface comprises a wireless interface.

3. The system of claim 1 where the interface comprises a standardized computer communication interface.

4. The system of claim 1 where the interface provides power from the equipment to the occupancy sensor.

5. The system of claim 1 further comprising a switch arranged to control power to the equipment in response to the occupancy sensor.

6. The system of claim 5 where the advance notification comprises a command to cause the equipment to perform an orderly shutdown.

7. The system of claim 6 where the advance notification comprises a transmission of one or more control characters.

8. The system of claim 1 further comprising a second interface to couple the occupancy sensor to a switch to control power to the equipment in response to the occupancy sensor.

9. The system of claim 8 where the second interface comprises a wireless interface.

10. A system comprising:
equipment having power reduction capability; and
an interface to couple the equipment to an occupancy sensor;
where the equipment may perform a power reduction operation in response to the occupancy sensor.

11. The system of claim 10 where the interface comprises a wireless interface.

12. The system of claim 10 where the interface comprises a standardized occupancy sensor interface.

13. The system of claim 10 where the equipment comprises a computer.

14. The system of claim 12 where the power reduction operation comprises an orderly shut-down operation.

15. The system of claim 10 further comprising a switch to control power to the equipment in response to the occupancy sensor.

16. The system of claim 15 where the switch is integral with the equipment.

17. A system comprising:
a node including:
a first interface to couple the node to an occupancy sensor; and
a second interface to couple the node to equipment having built-in power reduction capability;
where the node is adapted to send a notification to the equipment to enable the equipment to perform a built-in power reduction operation.

18. The system of claim 17 further comprising a switch to control power to the equipment in response to the occupancy sensor.

19. The system of claim 18 where the node and switch are included in a power strip.

20. The system of claim 19 where the first interface comprises a wireless interface and the second interface comprises a standardized computer communication interface.

21. The system of claim 20 where the standardized computer communication interface comprises a universal serial bus interface.

22. The system of claim 17 where the node comprises a network adapter.

23. The system of claim 17 where:
the node further comprises a third interface to couple the node to a switch to interrupt power to the equipment in response to the occupancy sensor;
the advance notification comprises a command to cause the equipment to perform an orderly shutdown; and
the node is adapted to provide the equipment adequate time to perform the orderly shutdown before the switch interrupts power to the equipment.

24. The system of claim 23 where:
the first interface comprise a wireless interface;
the second interface comprises a standardized computer communication interface; and
the third interface comprises a standardized building automation interface.

25. A system comprising:
equipment having power reduction capability; and
an occupancy sensor coupled to the equipment;
where the equipment may perform a power reduction operation in response to the occupancy sensor.

26. The system of claim 25 where:
the equipment comprises a computer; and
the power reduction operation comprises an orderly shutdown sequence.

27. The system of claim 25 further comprising a switch to control power to the equipment in response to the occupancy sensor.

28. The system of claim 27 further comprising logic to send an advance notification to the equipment before the switch interrupts power to the equipment.

29. The system of claim 28 where the logic may cause the switch to interrupt the power after a time delay from when advance notification was sent.

30. The system of claim 28 where the logic may not cause the switch to interrupt the power unless a confirmation is received from the equipment.

31. The system of claim 25 where the occupancy sensor receives power from the equipment.

32. A system comprising:
an occupancy sensor; and
a switch arranged to control power to equipment in response to the occupancy sensor;
where an advance notification is sent to the equipment to enable the equipment to perform a built-in power reduction operation before the switch interrupts power to the equipment in response to the occupancy sensor.

33. The system of claim 32 where the occupancy sensor is capable of sending the advance notification to the equipment.

34. The system of claim 32 where the switch is controlled by a node.

35. The system of claim 34 where the node includes the switch.

36. The system of claim 34 where the node comprises:
a first interface to couple the node to the occupancy sensor; and
a second interface to couple the node to the equipment.

37. The system of claim 36 where the node further comprises a third interface to couple the node to the switch.

38. The system of claim 32 further comprising an interface to couple the occupancy sensor to the equipment.

39. The system of claim 38 where the occupancy sensor and the interface are included in an assembly.

40. The system of claim 39 where the assembly includes the switch.

41. The system of claim 39 where the assembly includes a second interface to couple the switch to the assembly.

42. The system of claim 38 where the occupancy sensor and the equipment are included in an assembly.

43. The system of claim 32 further comprising logic to confirm a response to the advance notification before the switch interrupts power to the equipment.

44. The system of claim 43 where the response is confirmed by a signal from the equipment.

45. The system of claim 44 where the response is confirmed by monitoring the flow of power to the equipment.

46. A method comprising:
providing power to electrical equipment associated with a space;
monitoring the space for occupants;
sending a notification to some or all of the equipment in response to determining that the space is unoccupied; and
interrupting power to some or all of the equipment in response to determining that the space is unoccupied.

47. The method of claim 46 where providing power to the equipment comprises:
energizing a first receptacle; and
energizing a second receptacle.

48. The method of claim where 47 where interrupting power to the equipment comprises:
de-energizing the first and second receptacles in response to determining that the space is unoccupied; and
leaving the first receptacle energized until a first portion of the equipment is enabled to perform a power reduction operation in response to the notification.

49. The method of claim 48 where interrupting power to the equipment comprises de-energizing the second receptacle at about the same time as determining that the space is unoccupied.

50. The method of claim 49 where interrupting power to the equipment comprises:
de-energizing the first receptacle in response to determining that the space is unoccupied; and
leaving the second receptacle energized.

51. The method of claim 49 where sending a notification to some or all of the equipment comprises sending a shutdown command to a computer.
